(19) United States
(12) Patent Application Publication
(10) Pub. No.: US 2025/0130537 A1
(43) Pub. Date: Apr. 24, 2025

(54) SUSTAINABLY HARVESTING POWER FROM PRINTED OBJECTS

(71) Applicant: INTERNATIONAL BUSINESS MACHINES CORPORATION, ARMONK, NY (US)

(72) Inventors: Fang Lu, Billerica, MA (US); Jeremy R. Fox, Georgetown, TX (US); Sarbajit K. Rakshit, Kolkata (IN); Tushar Agrawal, West Fargo, ND (US)

(21) Appl. No.: 18/491,885

(22) Filed: Oct. 23, 2023

(51) Int. Cl. G05B 13/02

(52) U.S. Cl. CPC G05B 13/0265

(57) ABSTRACT

A method, computer system, and a computer program product for sustainable power harvesting is provided. The present invention may include constructing a knowledge corpus using data received from a plurality of sources regarding electrical power harvesting from smart materials. The present invention may include determining one or more objects to be utilized for generating electrical power, wherein the one or more objects are comprised of at least one or more smart materials. The present invention may include generating printing instructions for the one or more objects to be executed by a three-dimensional (3D) printer. The present invention may include monitoring a performance of the one or more objects within an environment.

### BACKGROUND

The present invention relates generally to the field of computing, and more particularly to renewable and sustainable energy sources.

Modern society has seen an increasing demand for renewable and sustainable energy sources which has led to the development of technologies for harvesting energy from the environment. One of these developing technologies which may be promising is the use of different smart materials in harvesting energy. Smart materials, also referred to as intelligent or responsive materials, may include materials that are designed to have one or more properties that may be changed in a controlled fashion by external stimuli. These changes from external stimuli may result in the conversion of potential energy into electrical energy which may have the potential to be captured and provide a renewable and sustainable energy source.

### SUMMARY

Embodiments of the present invention disclose a method, computer system, and a computer program product for renewable and sustainable energy sources. The present invention may include constructing a knowledge corpus using data received from a plurality of sources regarding electrical power harvesting from smart materials. The present invention may include determining one or more objects to be utilized for generating electrical power, wherein the one or more objects are comprised of at least one or more smart materials. The present invention may include generating printing instructions for the one or more objects to be executed by a three-dimensional (3D) printer. The present invention may include monitoring a performance of the one or more objects within an environment.

In another embodiment, the method may include analyzing the data received from the plurality of sources using one or more machine learning models, generating insights for a plurality of smart materials and storing the insights in the knowledge corpus, and retraining the one or more machine learning models based on the performance of the one or more objects within the environment.

In a further embodiment, the method may include simulating a performance of a plurality of candidate objects under a plurality of conditions of the environment using one or more forecasting machine learning models.

In yet another embodiment, the method may include ranking the plurality of candidate objects based on the simulated performance using a machine learning based recommendation system, displaying the ranking of the plurality of candidate objects to a user within a sustainable energy user interface, and receiving one or more selections from the plurality of candidate objects from the user, wherein the one or more selections received from the user are the one or more objects to be utilized for generating the electrical power.

In addition to a method, additional embodiments are directed to a computer system and a computer program product for renewable and sustainable energy sources by using machine learning models to predict energy which may be harvested for an environment from one or more objects comprised of smart materials based on a continuously updated knowledge corpus and retraining those machine learning models based on additional data received during the monitoring of the one or more objects performance within the environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for sustainable power harvesting according to at least one embodiment.

### DETAILED DESCRIPTION

The following described exemplary embodiments provide a system, method and program product for sustainable power harvesting. As such, the present embodiment has the capacity to improve the technical field of renewable and sustainable energy sources by using machine learning models to predict energy which may be harvested for an environment from one or more objects comprised of smart materials based on a continuously updated knowledge corpus and retraining those machine learning models based on additional data received during the monitoring of the one or more objects performance within the environment. More specifically, the present invention may include constructing a knowledge corpus using data received from a plurality of sources regarding electrical power harvesting from smart materials. The present invention may include determining one or more objects to be utilized for generating electrical power, wherein the one or more objects are comprised of at least one or more smart materials. The present invention may include generating printing instructions for the one or more objects to be executed by a three-dimensional (3D) printer. The present invention may include monitoring a performance of the one or more objects within an environment.

As described previously, modern society has seen an increasing demand for renewable and sustainable energy sources which has led to the development of technologies for harvesting energy from the environment. One of these developing technologies which may be promising is the use of different smart materials in harvesting energy. Smart materials, also referred to as intelligent or responsive materials, may include materials that are designed to have one or more properties that may be changed in a controlled fashion by external stimuli. These changes from external stimuli may result in the conversion of potential energy into electrical energy which may have the potential to be captured and provide a renewable and sustainable energy source.

Therefore, it may be advantageous to, among other things, construct a knowledge corpus using data received from a plurality of sources regarding electrical power harvesting from smart materials, determine one or more objects to be utilized for generating electrical power, wherein the one or more objects are comprised of at least one or more smart materials, generate four-dimensional (4D) printing instructions for the one or more objects to be executed by a three-dimensional (3D) printer, and monitor a performance of the one or more objects within an environment.

According to at least one embodiment, the present invention may improve sustainable energy harvesting by constructing a knowledge corpus using insights generated from a machine learning model and natural language processing analysis of data received from a plurality of sources as well as data provided by the user with respect to an environment. Then leveraging the knowledge corpus to determine one or more objects which may best be utilized for generating electrical power for the environment and gathering additional performance data for those objects and retraining the one or more machine learning models to provide more efficient recommendations.

According to at least one embodiment, the present invention may improve sustainable energy harvesting by simulating a performance of a plurality of candidate objects under a plurality of environmental conditions using one or more forecasting machine learning model before ranking the plurality of candidate objects and displaying the ranked candidate objects to the user in a sustainable energy user interface enabling the user to select the objects to be used for energy generation within the environment.

According to at least one embodiment, the present invention may improve the identification of which smart materials (e.g., intelligent materials, responsive materials) may be best for the composition of one or more objects to be utilized in generating electrical power for an environment by utilizing a web-crawler and/or other search mechanisms as well as natural language processing techniques to generate insights with respect to a plurality of smart materials.

According to at least one embodiment, the present invention may improve the energy efficiency of an environment identified by the user by determining one or more objects which may be the most efficient for supplementing power generation based on external stimuli which may be safely applied to the smart materials of the one or more objects within the environment and generating printing instructions for the one or more objects to be executed on a three-dimensional (3D) printer. This may additionally, reduce the emissions of the user's environment, reduce maintenance requirements and/or strain on existing energy production solutions, enable the ability to provide split power to different components within the environment, amongst other performance improvements.

According to at least one embodiment, the present invention may improve the safety of sustainable energy harvesting by considering operational safety factors involved based on the environment and the smart materials (e.g., intelligent materials, responsive materials) involved and may institute these operational safety measures automatically and/or provide instructions to the user.

According to at least one embodiment, the present invention may improve the cost effectiveness of sustainable energy harvesting by identifying one or more pre-existing objects within an environment which may be converted to a power generating 4D object through the application of smart materials (e.g., intelligent materials, responsive materials) designed specifically for those objects and printed such that they may be applied directly and/or with clamps or adhesive. Furthermore, the present invention may improve cost efficiencies by utilizing naturally occurring external stimuli already present within the environment, such as light.

According to at least one embodiment, the present invention may improve electrical power harvesting from smart materials by making environment specific recommendations based on at least data retrieved from existing sources and a user.

According to at least one embodiment, the present invention may improve energy harvesting from 4D objects by identifying smart materials which may safely produce sustainable energy within the environment and generating printing instructions for the one or more objects based on the 3D printer specifications available to a user.

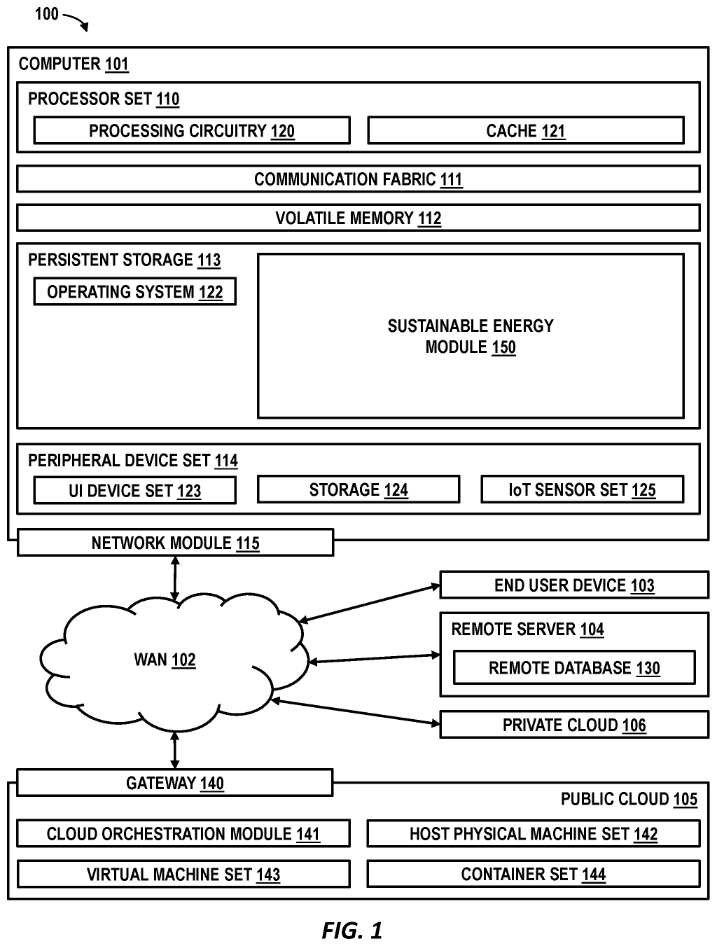

Referring to FIG. 1, Computing environment 100 contains an example of an environment for the execution of at least some of the computer code involved in performing the inventive methods, such as determining one or more objects to be comprised of at least one or more smart materials which may be utilized in providing a sustainable energy solution to an environment identified by a user using the sustainable energy module 150. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

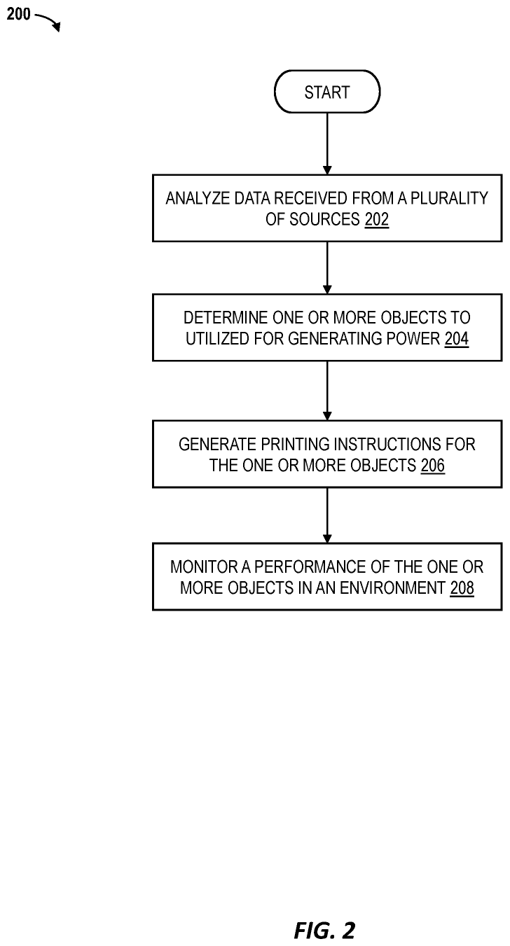

According to the present embodiment, the computer environment 100 may use the sustainable energy module 150 to predict energy which may be harvested from an environment using one or more objects comprised of smart materials based on a continuously updated knowledge corpus which may be utilized in training and retraining one or more machine learning models. The sustainable power harvesting method is explained in more detail below with respect to FIG. 2.

Referring now to FIG. 2, an operational flowchart illustrating the exemplary sustainable power harvesting process 200 used by the sustainable energy module 150 according to at least one embodiment is depicted.

At 202, the sustainable energy module 150 constructs a knowledge corpus (e.g., database 130). The sustainable energy module 150 may construct the knowledge corpus (e.g., database 130) by analyzing data received from a plurality of sources regarding electrical power harvesting from smart materials (e.g., intelligent materials, responsive materials) and four-dimensional (4D) printing. As will be described in more detail below, the data received from the plurality of sources regarding electrical power harvesting from smart materials (e.g., intelligent materials, responsive materials) and 4D printing may be utilized in constructing the knowledge corpus (e.g., database 130) which may be a public cloud based corpus utilized by the sustainable energy module 150 in generating databases dedicated to at least the three-dimensional (3D) printers utilized in producing the one or more 4D printed objects based on the instructions generated by the sustainable energy module 150 and/or usage criteria of the one or more 4D printed objects for the user.

Smart materials (e.g., intelligent materials, responsive materials) may be materials that are designed to include one or more properties which may be altered in a controlled fashion by external stimuli, such as, but not limited to, stress, moisture, electric fields, magnetic fields, light, temperature, potential of hydrogen (“pH”), chemical compounds, amongst other external stimuli which may be applied. Examples of smart materials (e.g., intelligent materials, responsive materials) may include, but are not limited to including, piezoelectric materials, shape-memory alloys, shape-memory polymers, photovoltaic materials, electroactive polymers (“EAPs”), magnetostrictive materials, magnetic shape memory alloys, smart inorganic polymers, pH-sensitive polymers, temperature-responsive polymers, halochromic materials, chromogenic systems, ferrofluids, photomechanical materials, polycaprolactone, self-healing materials, dielectric elastomers (Des), magnetocaloric materials, thermoelectric materials, chemoresponsive materials, amongst other materials which are designed to include one or more properties which may be altered in a controlled fashion by external stimuli. As will be explained in more detail below, 4D printing utilizes a 3D printer to create live three dimensional objects which may not require wires or circuits due to the utilization of one or more smart materials (e.g., intelligent materials, responsive materials) which may be programmed to change shape, color, size, and/or other properties upon receiving an external stimulus. For example, piezoelectric materials are materials that may produce a voltage when stress is applied, suitably designed structures made from these materials can be made to bend, expand, or contract when a voltage is applied. Shape-memory alloys and shape-memory polymers are materials in which a large deformation may be induced and recovered through temperature or stress changes. Photovoltaic materials or optoelectronics may convert light to an electrical current. Magnetocaloric materials may be compounds that undergo a reversible change in temperature upon exposure to a changing magnetic field.

The plurality of sources from which the sustainable energy module 150 may receive data to analyze may include, but are not limited to including, information from various sources such as the internet, databases, and scientific literature including research papers, articles, reports, and other relevant documents related to power harvesting, smart materials, 4D printing, sensors, one or more Internet of Things (IoT) devices, and electronic knowledge sources associated with an environment identified by the user within the sustainable energy user interface which will be described in more detail below. The sustainable energy module 150 may utilize technologies such as, but not limited to, machine learning algorithms, artificial intelligence, computer vision, natural language processing (NLP) and/or other linguistic analysis techniques in analyzing data from the plurality of sources regarding electrical power harvesting from smart materials (e.g., intelligent materials, responsive materials) and 4D printing. This information may further be used to detect patterns in the data and extract useful information, such as potential 4D printed objects and influencing factors that may impact electrical power harvesting within an environment. The data derived from the plurality of sources and the analysis of that data may be stored in the knowledge corpus (e.g., database 130). The data may be continuously derived from the plurality of sources by the sustainable energy module 150 and the analysis of the data may be continuously and/or intermittently performed as new data is received which may continuously refine and/or update the analysis and data stored in the knowledge corpus (e.g., database 130).

The sustainable energy module 150 may utilize a web-crawler and/or other search mechanism as well as the NLP techniques and other linguistic analysis techniques described in more detail below in identifying the various sources of content and the relevant information within the various sources. The other search mechanisms may include search mechanisms implemented in IBM Watson® (IBM Watson and all Watson-based trademarks are trademarks or registered trademarks of International Business Machines Corporation in the United States, and/or other countries), such as IBM Watson® Speech Recognition, IBM Watson® Speech to Text, IBM Watson® Text to Speech, and IBM Watson® Natural Language Understanding, amongst other search and/or content identification mechanisms. The sustainable energy module 150 may utilize NLP and/or one or more linguistic analysis techniques in analyzing the data from the plurality of sources. The one or more linguistic analysis techniques may include, but are not limited to including, a machine learning model with NLP, Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States. and/or other countries), IBM Watson® Speech to Text, IBM Watson® Tone Analyzer, IBM Watson® Natural Language Understanding, IBM Watson® Natural Language Classifier, amongst other implementations. The NLP and/or one or more linguistic analysis techniques may be utilized by the sustainable energy module in analyzing the data received and/or accessed from the plurality of sources. As will be described in more detail below, the sustainable energy module 150 may utilize the NLP and/or linguistic analysis in identifying smart materials and locations within the environment that may be the most efficient means of power generation. The sustainable energy module 150 may utilize the information and/or data retrieved in additionally generating insights with respect to a plurality of smart materials and storing those insights in the knowledge corpus (e.g., database 130).

The user and/or other authorized party may also identify relevant content and/or content sources to be analyzed by the sustainable energy module 150 within the sustainable energy user interface. The sustainable energy module 150 may display the sustainable energy user interface to the user in at least, an internet browser, dedicated software application, and/or as an integration with a third party software application. Data which may be received and/or provided by the user in the sustainable energy user interface may include, but is not limited to including, details about an environment for which the one or more 4D printed objects may be generated in order to supplement energy needs through electrical power harvesting from smart materials (e.g., intelligent materials, responsive materials). The environment may be a structure requiring electrical energy to operate such as, but not limited to, a house, school, store, office, factory, laboratory, amongst other structures. Details about the environment which may be provided by the user within the sustainable energy user interface may include, the location, energy requirements of the environment, amount of energy the user would like to supplement with energy harvested from the one or more 4D printed objects, energy usage records, square footage, property size, materials utilized in construction, window types, year built, blueprints, roofing details, architecture, information on appliances, access to smart materials (e.g., intelligent materials, responsive materials), on-site 3D printer capabilities, safety requirements, primary use of the structure and/or environment, amongst other environmental data and/or information.

The user may also enable data sharing from one or more devices associated with the environment. The one or more devices associated with the environment may include, but are not limited to including, one or more IoT devices connected to at least one sensor (e.g., temperature sensor, motion sensor, humidity sensor, pressure sensor, accelerometers, gas sensor, multi-purpose IoT sensor, among other sensors), the one or more IoT devices associated with the environment may also capture images, videos, thermal imagery, and/or 3D scans of the environment, smart electricity monitors, energy meters, amongst other devices associated with the environment in which the user may permit direct data sharing. The sustainable energy module 150 may utilize computer vision in at least deriving information about the environment identified by the user based on the images, videos, thermal imagery, and/or 3D scans which may enable the sustainable energy module 150 to identify one or more objects within the environment which may be converted to a 4D printed object and/or areas within the environment which the one or more 4D printed objects should be placed. The computer vision algorithms utilized by the sustainable energy module 150 may include, but are not limited to including, Scale-Invariant feature transform (SIFT), Affine-SIFT (ASIFT), Speeded Up Robust Features (SURF), Histogram of Orientated Gradients (HOG), amongst other computer vision algorithms which may utilize one or more convolutional neural networks (CNNs) and/or Deep-CNNs, as well as supervised/unsupervised image classification techniques in analyzing the environment. The sustainable energy module 150 may utilize the images, videos, thermal imagery, and/or 3D scans captured by the one or more IoT devices to capture objects within the environment. The sustainable energy module 150 may analyze those images using the computer vision based techniques described above, such as, CNNs. The sustainable energy module 150 may utilize the convolutional layers, which may be two dimensional (2D) surfaces for learning from correlations between image pixels. The sustainable energy module 150 may continuously feed images and/or video to the CNNs enabling the CNNs to adjust their parameters and constantly improve the output. For example, the sustainable energy module 150 may identify areas within the environment that receive the most direct sunlight, have the highest temperature, and/or are proximate to an existing energy source. As will be explained in more detail below, the sustainable energy module 150 may utilize the data received from the one or more devices associated with the environment, environmental data received from the user, and/or additional environmental data derived from other data sources in determining the plurality of conditions under which a plurality of candidate objects may be simulated using a forecasting machine learning model to accurately predict the power generation which mat be provided to the environment by one or more objects. In another example, the sustainable energy module 150 may utilize the computer vision techniques described above to identify objects within the existing environment which may be converted to 4D objects and enable the user to maximize space and cost of the environment.

As will be explained in more detail below, the computer vision algorithms, CNNs and Deep-CNNs described above which may be utilized in analyzing the images, videos, thermal imagery, and/or 3D scans of the environment may be only part of the analysis performed by the sustainable energy module which may employ a hybrid model approach, the hybrid model being trained to combine the predictions of two or more machine learning models.

All data received from the user and/or the one or more devices associated with the environment shall not be construed as to violate or encourage the violation of any local, state, federal, or international law with respect to data privacy. The user may be able to update the one or more devices permitted for data sharing and/or any other information provided to the sustainable energy module 150 at any time within the sustainable energy user interface. The sustainable energy module 150 may store the information provided by the user and/or the data received from the one or more devices specific to the user's designated environment in the knowledge corpus (e.g., database 130) and/or in a personal knowledge corpus (e.g., personal database which has the same capabilities as database 130). As will be explained in more detail below, the data, analysis, and insights stored within the knowledge corpus (e.g., database 130) and/or the personal knowledge corpus (e.g., personal database) may be utilized in training the one or more machine learning models, as input for the one or more machine learning algorithms, training the one or more forecasting machine learning models, and/or refining the simulation processes described at step 204. As additional data, information, and/or feedback is received by the sustainable energy module 150 the sustainable energy module 150 may retrain the one or more machine learning models and/or one or more forecasting machine learning models to provide at least improved printing instructions for the one or more 4D objects to the 3D printer, more accurately recommend specific smart materials for the one or more 4D printed objects, improve the efficiency of generating electrical power and/or harvesting electrical power from the one or more 4D printed objects, amongst other improvements which will be described in further detail below.

The plurality of smart materials (e.g., intelligent materials, responsive materials) which may be utilized for 4D printing may be classified using the methods described above based on at least the environment in which power is to be generated and the external stimuli for which each of the plurality of smart materials react with. For example, materials which react when in contact with water or moisture are classified under a particular category. These materials may be favored due to the abundancy of water and the range of applications in which these external stimuli may be employed. One example, hydrogel, would be categorized under this particular category due to its vigorous reaction to water. Similarly, other smart materials (e.g., intelligent materials, responsive materials) may be categorized under, for example, light, magnetic fields, and currents. One example, photographic chromophores swell with polymers at a specific location and when exposed to natural light they may absorb the light. Similarly, when a current is applied to an ethanol-containing object, the volume may increase, and the overall matrix may be enlarged. Thus, magnetic nanoparticles may be integrated into the 4D printed object to enable magnetic control of the object.

The sustainable energy module 150 may also utilize one or more machine learning models and/or artificial intelligence in analyzing the data stored in the knowledge corpus (e.g., database 130) and/or the personal knowledge corpus (e.g., personal database) in predicting an amount of power that may require generation and harvesting from one or more 4D printed objects comprised of one or more smart materials. The one or more machine learning models may utilize one or more machine learning algorithms, such as, but not limited to, regression factoring, decision trees, support vector machines, and neural networks. The sustainable energy module 150 may utilize the support vector machines to classify the data by finding an optimal decision boundary that maximally separates different classes. The support vector machines may aim to find the best hyperplane that maximizes the margin between support vectors which may enable effective classification in complex, non-linear scenarios. A decision tree is a type of supervised machine learning algorithm which may be utilized by the sustainable energy module 150 in categorizing and/or making predictions based on the plurality of data received based on how previous questions may have been answered. The model is a form of supervised learning, meaning that the model is trained and tested on a set of data that contains the desired categorization. Additionally, decision trees may be useful for categorizing results when attributed may be sorted against known criteria to determine a final category by mapping possible outcomes of a series of related choices. In addition to utilizing the one or more machine learning models in constructing the knowledge corpus (e.g., database 130) and continuously refining the data stored in the knowledge corpus (e.g., database 130) the sustainable energy module 150 may also leverage these machine learning algorithms in determining the one or more smart materials which may comprise the one or more 4D printed objects, and an external stimulus which may be applied to the one or more 4D printed objects in order to produce the amount of energy required for the environment. The one or more machine learning algorithms utilized by the sustainable energy module 150 may be described in more detail below in at least step 204. Additionally, as described in more detail above the sustainable energy module 150 may employ a hybrid model approach, the hybrid model being trained to combine the predictions of two or more machine learning models, such as, for example, the machine learning model with NLP, the CNN utilized in the computer vision analysis, and the one or more machine learning algorithms described above which may be utilized by the one or more machine learning models and/or artificial intelligence.

At 204, the sustainable energy module 150 determines one or more objects to be utilized for generating electrical power. The sustainable energy module 150 may determine the one or more objects to be utilized for generating electrical power in an environment based on at least the analysis of the data received and/or accessed at step 202. The sustainable energy module 150 may identify one or more objects for 4D printing and identify one or more smart materials to be utilized in the 4D printing using the analysis and insights derived from the one the one or more machine learning models, artificial intelligence, computer vision, NLP, and linguistic analysis techniques for the plurality of data received and/or accessed at step 202.

The sustainable energy module 150 may utilize the hybrid model described in detail at step 202 in identifying a plurality of candidate objects which may be utilized for generating electrical power in the environment identified by the user based on the analysis and insights provided according to the data analysis methods described at step 202. The plurality of candidate objects identified by the sustainable energy module may include details derived from the hybrid model such as, but not limited to, object design, smart materials (e.g., intelligent materials, responsive materials) and/or other material composition, intensity of influencing factors and/or external stimuli to be applied and when, shapes of the objects, location of object within the environment, amongst other details. The plurality of candidate objects may each replace a pre-existing object within the environment, adding smart materials to a pre-existing object within the environment, and/or a new object which may be printed in its entirety using smart materials (e.g., intelligent materials, responsive materials) and/or other materials.

The sustainable energy module 150 may then utilize one or more forecasting machine learning models and/or simulation processes in simulating a performance of the plurality of candidate objects within the environment. The one or more forecasting machine learning models utilized by the sustainable energy module 150 may include at least a Monte Carlo simulation process, agent based simulation model, discrete event simulation model, and/or a system dynamic simulation model, amongst other simulation methods. The sustainable energy module 150 may additionally utilize a statistical program such as IBM's SPSS® (SPSS® and all SPSS-based are trademarks or registered trademarks of International Business Machines Corporation in the United States, and/or other countries), or Statistical Product and Service Solution, in optimizing the one or more forecasting machine learning models and/or the simulation process. The sustainable energy module 150 may simulate each of the plurality of candidate objects under a plurality of conditions within the environment, wherein the plurality of conditions may be generated based on the information stored in the personal knowledge corpus (e.g., personal database), such as, historical energy consumption, historical data received from the one or more IoT devices associated with the environment, and/or additional data retrieved by the sustainable energy module 150 relating to the environment, such as, historical weather patterns and/or sunlight received at the geographic area corresponding to the environment amongst other influencing factors. The sustainable energy module 150 may also consider the external stimuli and level of each external stimuli that may be applied to the one or more candidate objects, such as, temperature, light, pressure, electricity, voltage, pH, steam, and/or chemical compounds. The sustainable energy module 150 may determine the one or more objects and/or present the plurality of candidate objects to the user based on the most suitable smart materials (e.g., intelligent materials, responsive materials) for the environment in which the external stimuli may be safely applied.

The sustainable energy module 150 may determine the one or more objects to be utilized for generating electrical power within the environment based on the performance of the plurality of candidate objects within the environment. Alternatively, the sustainable energy module 150 may rank the plurality of candidate objects based on performance metrics recorded for the one or more simulations, preferences and/or energy needs of the user, case of maintenance and/or replacement, energy usage patterns, safety protocols, amongst other information which may be utilized in ranking the plurality of candidate objects. The sustainable energy module 150 may display these rankings to the user within the sustainable energy user interface along with details such as an amount of energy projected to be produced by each of the plurality of candidate objects and/or other information utilized in ranking the plurality of candidate objects. The sustainable energy module 150 may additionally enable the user to select one or more objects from the plurality of candidate objects based on the rankings and the information provided. The rankings of the plurality of candidate objects may be generated using a machine learning based recommendation system, which may be retrained to re-rank future candidate objects based on the selections and/or feedback provided by the user within the sustainable energy user interface, both of which may be stored in the personal knowledge corpus (e.g., personal database) and utilized in developing a machine learning based recommendation system for each user of the sustainable energy module 150. As will be explained in more detail below with respect to at least step 206, the sustainable energy module 150 may generate printing instructions based on the selections received from the user within the sustainable energy user interface.

In an embodiment, the sustainable energy module 150 may also automate and/or conduct data analysis of the data stored in the knowledge corpus (e.g., database 130) using code constructed to perform the smart material derivation task and identify the appropriate smart materials (e.g., intelligent materials, responsive materials) to be utilized in power harvesting. The sustainable energy module 150 may utilize one or more computer programming languages and utilize parameters such as a list of influencing factors and their respective intensities. The sustainable energy module 150 may loop through the list of influencing factors and their respective intensities and use a series of if-else statements to identify the appropriate smart materials to be utilized for power harvesting. For example, the Python® (Python® and all Python-based trademarks are trademarks or registered trademarks of The Python Software Foundation (PSF) in the United States, and/or other countries) code snippet below may describe an implementation for temperature and light in smart material derivation which may be utilized by the sustainable energy module 150:

```
def identifyMaterial(influencingFactors, intensities):
  for i in range(len(influencingFactors)):
    factor = influencingFactors[i]
    intensity = intensities[i]
    if(factor == “temperature”):
    if(intensity < 20):
      # identify material for low temperatures
    elif(intensity > 50):
# identify material for high temperatures
else:
# identify material for moderate temperatures
elif(factor == “light”):
if(intensity < 5):
# identify material for low light
elif(intensity > 10):
#identify material for high light
else:
# identify
```

The sustainable energy module 150 may additionally utilize the specifications of the 3D printer to be used in printing the one or more 4D printed objects, materials available to the user, and other information described in detail below which may be analyzed using artificial intelligence, machine learning algorithms, machine learning models, computer vision, natural language processing (NLP), linguistic analysis techniques, amongst other methods to identify a plurality of candidate objects and/or determine the one or more objects to be utilized for power generation and harvesting within the environment.

At 206, the sustainable energy module 150 generates printing instructions for the one or more objects. The sustainable energy module 150 may generate the 4D printing instructions for the one or more objects determined at step 204, either by the sustainable energy module 150 or selected by the user, to be utilized in the generating of electrical power for the environment identified by the user.

The printing instructions may include a 3D model of the one or more 4D objects to be printed. The sustainable energy module 150 may utilize a computer-aided design (CAD) package in generating a 3D model for each of the one or more objects. The sustainable energy module 150 may utilize the one or more objects determined at step 204, the influencing factors which may affect the object, amongst other factors in designing the 3D model of the one or more 4D printed objects to maximize the power output when exposed to the influencing factors and/or external stimuli. The printing instructions generated by the sustainable energy module 150 may be for the replacement of a pre-existing object within the environment, for smart material printing instructions to be added to an existing object within the environment to create a 4D printed object, and/or a new object which may be printed in its entirety using smart materials (e.g., intelligent materials, responsive materials) and/or other materials.

The sustainable energy module 150 may generate the 4D printing instructions for the one or more objects based on at least the specifications of a 3D printer, the one or more smart materials (e.g., intelligent materials, responsive materials) to be used, and/or an amount of power generation required for the environment identified by the user, amongst other factors. The sustainable energy module 150 may design the 4D printed object, select the smart materials and/or other materials, and determine the structural strength requirements of the one or more objects. The printing instructions may also include local geographical factors which should be maintained during the printing process such as temperature and/or humidity levels to ensure an optimal environment for printing of the 4D object. In addition to the monitoring of the printing process described in more detail below, the sustainable energy module 150 may ensure the 3D printer is connected to a reliable power source, ensure an appropriate filament spool and clean nozzle, and directly pre-heat the printer bed and nozzle temperatures to a desired level in accordance with the printing instructions.

The specifications of the 3D printer may include, but are not limited to including, print chamber dimensions, 3D printer make and model, nozzle dimensions, nozzle materials, amongst other specifications. The print chamber dimensions may refer to space available for a 3D printer to print the one or more objects, wherein the width and length dimensions may be the surface area of a print bed. The print bed may be the part of the 3D printer in which the 3D printed object rests during the printing process. The 3D printer identified by the user within the sustainable energy user interface may be equipped with one or more IoT devices. The one or more IoT devices may each be connected to (e.g., equipped with) with at least one or more cameras, wherein the one or more cameras may cover different zones of the layers being produced during the printing process. Images and/or video captured by the one or more IoT devices during the printing process of the one or more objects may be transmitted by the sustainable energy module 150 such that live feed may be displayed in the sustainable energy user interface and enable both the sustainable energy module 150 and/or the user to monitor the printing process of the one or more 4D printed objects. In some embodiments, the one or more IoT devices may each be mounted on a movable platform and the cameras associated with the IoT devices may have the ability to pan, tilt, and/or zoom in order to narrow in on a particular area for quality checking from various angles and/or zoom levels. The one or more IoT devices may also be connected to (e.g., equipped with) light sensors and/or an ultrasonic capable microphone amongst other sensors which may be utilized in further monitoring and/or identifying deviations in the printing process of the one or more 4D printed objects, such as, but not limited to, temperature monitoring, filament pressure readings, thickness of layers, and/or cracks or other defects during the print, amongst other deviations which may occur during the printing process. The sustainable energy module 150 may also calibrate the printer for the specific design of the one or more objects.

The user may identify the 3D printer to be utilized within the sustainable energy user interface. The user may identify the specific model within the sustainable energy user interface and/or connect one or more 3D printers to the user's account which may be stored in the personal knowledge corpus (e.g., personal database) which may enable the sustainable energy module 150 to consider multiple options and design the plurality of candidate objects such for any of the one or more printers and/or printer specific object models.

Following the completion of the printing process the sustainable energy module 150 may provide installation instructions. Installation instructions may include, but are not limited to including, recommended locations for the one or more 4D printed objects within the environment identified by the user, type of external stimuli and/or influencing factors to be applied to each of the one or more objects, replacement and/or maintenance instructions, operational safety factors, environmental factors which may impact the amount of electrical power harvesting, instructions for applying the smart material to an existing object, instructions for connecting the one or more 4D printed objects to a power harvesting system, amongst other installation instructions and/or recommendations. The installation instructions and/or recommendations may be displayed to the user within the sustainable energy user interface. For example, the sustainable energy module 150 may consider the operational safety factors of the one or more objects within the environment and provide instructions as to the proper isolation of devices and/or objects properly when harvesting power. Because the 4D printing process involves the object transformation process into another structure under the influence of external energy input such as, but not limited to, temperature, light, amongst other stimuli, the sustainable energy module 150 considers the different scenarios such that the devices and object may be isolated properly when harvesting power. The sustainable energy module 150 may institute these operational safety measure automatically utilizing the microcontrollers and/or other controllable devices within the environment and/or provide instructions to the user with respect to safety measure which should be taken.

The sustainable energy module 150 may utilize an intelligent real estate and/or facilities management solution, such as, but not limited to IBM TRIRIGA® (IBM TRIRIGA® and all IBM TRIRIGA-based trademarks are trademarks or registered trademarks of International Business Machines Corporation in the United States, and/or other countries), in providing the installation instructions and/or one or more recommendations to the user within the sustainable energy user interface. As will be explained in more detail below, the sustainable energy module 150 may also utilize the intelligent real estate and/or facilities management solution in monitoring the environment and/or managing the one or more 4D printed objects and total power generation.

At 208, the sustainable energy module 150 monitors the performance of the one or more objects within the environment. The sustainable energy module 150 monitor the performance of the one or more objects within the environment based on power generating data collected. The power generating data may be collected by the sustainable energy module 150 using one or more communication protocols, such as, but not limited to, Wi-Fi, Bluetooth® (Bluetooth and all Bluetooth-based trademarks and logos are trademarks or registered trademarks of Bluetooth SIG. Inc. and/or its affiliates). Zigbee® (Zigbee and all Zigbee-based trademarks and logos are trademarks or registered trademarks of Connectivity Standards Alliance, and/or its affiliates), amongst other communication protocols.

The one or more communication protocols described above may also be utilized in retrieving data from the one or more devices associated with the environment described above at step 202, such as, but not limited to, the one or more IoT devices connected to at least one sensor (e.g., temperature sensor, motion sensor, humidity sensor, pressure sensor, accelerometers, gas sensor, multi-purpose IoT sensor, among other sensors), the one or more IoT devices associated with the environment may also capture images, videos, thermal imagery, and/or 3D scans of the environment, smart electricity monitors, energy meters, amongst other devices associated with the environment in which the user may permit direct data sharing. The one or more devices and/or sensors utilized by the sustainable energy module 150 may differ depending on an external stimulus and/or influencing factor being utilized. For example, if the external stimulus being used for an object is light, then a photoresistor may be utilized to measure the amount of light in the environment. As will be described in more detail below, the sustainable energy module 150 utilizes the one or more 4D printed objects to harvest energy, the sensors may be utilized by the sustainable energy module in monitoring and/or measuring the changes within the environment to ensure the efficiency of energy generation. The energy may be stored in at least batteries, capacitors, and/or fuel cells. The sustainable energy module 150 additionally leverages the microcontrollers to manage the deformation process and/or external stimuli application to the one or more 4D printed objects with the communications of this process and overall operation being communicated through the one or more wireless protocols described above.

The one or more devices associated with the environment may perform readings, for example, temperature and/or humidity, which may be maintained on a subledger on each of the one or more devices associated with the environment, which may then utilize the one or more communication protocols described above in broadcasting the readings performed to a shared ledger maintained within the knowledge corpus (e.g., database 130) and/or personal knowledge corpus (e.g., personal database) which may be accessible to the user through the sustainable energy user interface. The user may set the performance reading schedules of the one or more devices within the environment in a user preferences section of the sustainable energy user interface. Additionally, the sustainable energy module 150 may utilize that data as input for at least the machine learning models, hybrid models, and forecasting models described at step 202 and 204 to provide updated insights to the user within the sustainable energy user interface, such as, but not limited to, average sustainable energy production for each of the one or more objects, projected energy cost savings for each of the one or more objects, daily energy production for each of the one or more objects, amongst other energy metric insights which may be provided to the user.

The communication protocol utilized by the sustainable energy module 150 for each object may be chosen based on at least a type of external stimulus and/or influencing factor to be applied to each of the one or more 4D printed objects and a distance between each of the 4D printed objects and the power harvesting system. The communication protocols may be utilized to communicate the progress of the energy harvesting to the sustainable energy module 150 from the 4D printed objects. For example, if the external stimulus is light and the 4D printed object is located within a few meters of the power harvesting system, then a wireless protocol such as Wi-Fi may be used.

The power harvesting systems utilized by the sustainable energy module may vary depending on the object and the stimulus being applied but may include, but are not limited to including, piezoelectric generators, dielectric elastomers, amongst other power harvesting systems which may enable sustainable processing and handling of energy. Piezoelectric generators may be utilized to produce voltage using piezoelectric materials which generate electrical charges when it experiences mechanical stresses such that the mechanical energy may be converted into electrical energy. For example, if the external stimulus applied to the 4D printed object is heat, then the smart material comprising the 4D printed object may deform in response to the increasing temperature. This deformation may be utilized by the sustainable energy module 150 as the mechanical stress for the piezoelectric generator which in turn may produce electrical energy in response. The electrical energy may then be appropriately stored in storage systems such as batteries, capacitors, and/or fuel cells which may then be utilized in supplementing the energy consumption of the environment.

The sustainable energy module 150 may analyze the power generating data received and control the one or more objects and/or the external stimulus/influencing factors being applied to the one or more objects using microcontrollers based on the analysis of the power generating data. The microcontrollers employed by the sustainable energy module 150 may also be utilized in processing data, creating commands, and/or controlling the 4D printing objects. The sustainable energy module 150 may generate commands automatically using the trained machine learning models described at steps 202 and 204 and/or generate recommended commands which may be executed upon the approval of the user within the sustainable energy user interface. These commands may utilize the one or more microcontrollers to adjust the external stimulus being applied to at least one of the one or more objects in order to generate a desired deformation response which may be consistent and offer a repeatable stream of electrical energy generation. The electrical energy being produced by the potential energy generated from the deformation of the one or more 4D printed objects.

Additionally, the sustainable energy module 150 may utilize the intelligent real estate and/or facilities management solution described in more detail above in monitoring the performance of the one or more objects within the environment and providing additional recommendations to optimize energy efficiency within the environment, such as, but not limited to, rearranging the one or more 4D printed objects and/or other physical assets within the environment, structural recommendations, window installations, amongst other environmental recommendations which may improve the energy efficiency of the environment.

The sustainable energy module 150 may utilize the data received from monitoring the performance of the one or more objects in updating the data stored in the knowledge corpus (e.g., database 130) and the personal knowledge corpus (e.g., personal database) which may be utilized in retraining the machine learning models utilized by the sustainable energy module 150. For example, the data received from monitoring the performance may be utilized in retraining the machine learning models described at step 202 to more accurately predict an amount of power that requires generating, the forecasting machine learning models described at 204 to more accurately simulate the performance of the plurality of candidate objects, and/or the machine learning based recommendation system described at 204 to more accurately rank candidate objects and provide more insightful recommendations to the user.

The sustainable energy module 150 may also request feedback from the user in the sustainable energy user interface. The sustainable energy module 150 may utilize the feedback received from the user in at least updating data stored in the personal knowledge corpus (e.g., personal database) which may then be utilized in retraining the machine learning models described above to provide more personalized and accurate recommendations to the user. The sustainable energy module 150 may rank the potential candidate objects for energy generation within the environment not only based on the simulated performance but the user's preferences. For example, the user may provide feedback with respect to Object 1, Object 2, and Object 3 and rate the satisfaction with respect to Object 1 and Object 2 higher than Object 3. Object 1 and Object 2 may utilize light as an external stimulus and Object 3 may utilize heat as an external stimulus. Despite the fact that Object 3 may produce more power the machine learning based recommendation system may rank future objects which utilize a light external stimulus higher to the user than future objects which utilize heat. Alternatively, the sustainable energy module 150 may design one or more objects which may utilize light that would be able to supplement the energy production of Object 3 and provide that recommendation to the user within the sustainable energy user interface as well as projected energy performance data which may be generated using the retrained forecasting machine learning models.

The sustainable energy module 150 may also utilize the data and/or feedback received from monitoring the objects within the environment in determining the reusability of the one or more objects within the environment and/or whether additional smart materials may need to be applied to the one or more objects in order to maintain the energy production goals. For example, the sustainable energy module 150 may utilize images and/or video captured from the one or more IoT devices associated with the environment as well as energy production data in providing one or more maintenance recommendations and/or replacement projections for each of the one or more objects within the environment.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for sustainable power harvesting, the method comprising:
constructing a knowledge corpus using data received from a plurality of sources regarding electrical power harvesting from smart materials;
determining one or more objects to be utilized for generating electrical power, wherein the one or more objects are comprised of at least one or more smart materials;
generating printing instructions for the one or more objects to be executed by a three-dimensional (3D) printer; and
monitoring a performance of the one or more objects within an environment.

2. The method of claim 1, wherein constructing the knowledge corpus further comprises:
analyzing the data received from the plurality of sources using one or more machine learning models; and
generating insights for a plurality of smart materials and storing the insights in the knowledge corpus.

3. The method of claim 1, further comprising:
retraining one or more machine learning models based on the performance of the one or more objects within the environment.

4. The method of claim 1, wherein determining the one or more objects to be utilized for generating the electrical power further comprises:
simulating a performance of a plurality of candidate objects under a plurality of conditions of the environment using one or more forecasting machine learning models.

5. The method of claim 4, wherein the plurality of conditions of the environment are determined based on insights derived by one or more machine learning models and natural language processing using the data received from the plurality of sources and environmental data provided by a user in a sustainable energy user interface.

6. The method of claim 4, further comprising:
ranking a plurality of candidate objects based on the simulated performance using a machine learning based recommendation system;
displaying the ranking of the plurality of candidate objects to a user within a sustainable energy user interface; and
receiving one or more selections from the plurality of candidate objects from the user, wherein the one or more selections received from the user are the one or more objects to be utilized for generating the electrical power.

7. The method of claim 6, wherein the one or more selections received from the user are stored in a personal knowledge corpus and utilized in retraining the machine learning based recommendation system to re-rank future candidate objects based on the one or more selections or feedback provided by the user.

8. A computer system for sustainable power harvesting, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
program instructions, stored on at least one of the one or more computer-readable storage media for execution by at least one of the one or more processors via at least one of the one or more memories, to construct a knowledge corpus using data received from a plurality of sources regarding electrical power harvesting from smart materials;
program instructions, stored on at least one of the one or more computer-readable storage media for execution by at least one of the one or more processors via at least one of the one or more memories, to determine one or more objects to be utilized for generating electrical power, wherein the one or more objects are comprised of at least one or more smart materials;
program instructions, stored on at least one of the one or more computer-readable storage media for execution by at least one of the one or more processors via at least one of the one or more memories, to generate printing instructions for the one or more objects to be executed by a three-dimensional (3D) printer; and
program instructions, stored on at least one of the one or more computer-readable storage media for execution by at least one of the one or more processors via at least one of the one or more memories, to monitor a performance of the one or more objects within an environment.

9. The computer system of claim 8, further comprising:
program instructions, stored on at least one of the one or more computer-readable storage media for execution by at least one of the one or more processors via at least one of the one or more memories, to analyze the data received from the plurality of sources using one or more machine learning models; and
program instructions, stored on at least one of the one or more computer-readable storage media for execution by at least one of the one or more processors via at least one of the one or more memories, to generate insights for a plurality of smart materials and storing the insights in the knowledge corpus.

10. The computer system of claim 8, further comprising:
program instructions, stored on at least one of the one or more computer-readable storage media for execution by at least one of the one or more processors via at least one of the one or more memories, to retrain one or more machine learning models based on the performance of the one or more objects within the environment.

11. The computer system of claim 8, wherein the program instructions to determine the one or more objects to be utilized for generating the electrical power further comprises:
program instructions, stored on at least one of the one or more computer-readable storage media for execution by at least one of the one or more processors via at least one of the one or more memories, to simulate a performance of a plurality of candidate objects under a plurality of conditions of the environment using one or more forecasting machine learning models.

12. The computer system of claim 11, wherein the plurality of conditions of the environment are determined based on insights derived by one or more machine learning models and natural language processing using the data received from the plurality of sources and environmental data provided by a user in a sustainable energy user interface.

13. The computer system of claim 11, further comprising:
program instructions, stored on at least one of the one or more computer-readable storage media for execution by at least one of the one or more processors via at least one of the one or more memories, to rank a plurality of candidate objects based on the simulated performance using a machine learning based recommendation system;
program instructions, stored on at least one of the one or more computer-readable storage media for execution by at least one of the one or more processors via at least one of the one or more memories, to display the ranking of the plurality of candidate objects to a user within a sustainable energy user interface; and
program instructions, stored on at least one of the one or more computer-readable storage media for execution by at least one of the one or more processors via at least one of the one or more memories, to receive one or more selections from the plurality of candidate objects from the user, wherein the one or more selections received from the user are the one or more objects to be utilized for generating the electrical power.

14. The computer system of claim 13, wherein the one or more selections received from the user are stored in a personal knowledge corpus and utilized in retraining the machine learning based recommendation system to re-rank future candidate objects based on the one or more selections or feedback provided by the user.

15. A computer program product for sustainable power harvesting, comprising:
one or more computer readable storage media, and program instructions collectively stored on the one or more computer readable storage media, the program instructions comprising:
program instructions, stored on at least one of the one or more computer-readable storage media, to construct a knowledge corpus using data received from a plurality of sources regarding electrical power harvesting from smart materials;
program instructions, stored on at least one of the one or more computer-readable storage media, to determine one or more objects to be utilized for generating electrical power, wherein the one or more objects are comprised of at least one or more smart materials;
program instructions, stored on at least one of the one or more computer-readable storage media, to generate printing instructions for the one or more objects to be executed by a three-dimensional (3D) printer; and
program instructions, stored on at least one of the one or more computer-readable storage media, to monitor a performance of the one or more objects within an environment.

16. The computer program product of claim 15, further comprising:
program instructions, stored on at least one of the one or more computer-readable storage media, to analyze the data received from the plurality of sources using one or more machine learning models; and
program instructions, stored on at least one of the one or more computer-readable storage media, to generate insights for a plurality of smart materials and storing the insights in the knowledge corpus.

17. The computer program product of claim 15, further comprising:
program instructions, stored on at least one of the one or more computer-readable storage media, to retrain one or more machine learning models based on the performance of the one or more objects within the environment.

18. The computer program product of claim 15, wherein the program instructions to determine the one or more objects to be utilized for generating the electrical power further comprises:
program instructions, stored on at least one of the one or more computer-readable storage media, to simulate a performance of a plurality of candidate objects under a plurality of conditions of the environment using one or more forecasting machine learning models.

19. The computer program product of claim 18, wherein the plurality of conditions of the environment are determined based on insights derived by one or more machine learning models and natural language processing using the data received from the plurality of sources and environmental data provided by the user in a sustainable energy user interface.

20. The computer program product of claim 18, further comprising:
program instructions, stored on at least one of the one or more computer-readable storage media, to rank a plurality of candidate objects based on the simulated performance using a machine learning based recommendation system;
program instructions, stored on at least one of the one or more computer-readable storage media, to display the ranking of the plurality of candidate objects to a user within a sustainable energy user interface; and
program instructions, stored on at least one of the one or more computer-readable storage media, to receive one or more selections from the plurality of candidate objects from the user, wherein the one or more selections received from the user are the one or more objects to be utilized for generating the electrical power.
